(19) United States
(12) Patent Application Publication
(10) Pub. No.: US 2013/0200962 A1
(43) Pub. Date: Aug. 8, 2013

(54) TUNABLE PATCH RESONATOR FILTER

(71) Applicants: Ariana Serrano, Sao Paulo (BR); Philippe Ferrari, Sonnaz (FR); Fatima Correra, Sao Paulo (BR); Tân-Phu Vuong, Grenoble (FR)

(72) Inventors: Ariana Serrano, Sao Paulo (BR); Philippe Ferrari, Sonnaz (FR); Fatima Correra, Sao Paulo (BR); Tân-Phu Vuong, Grenoble (FR)

(73) Assignee: UNIVERSITE JOSEPH FOURIER, Grenoble Cedex 9 (FR)

(21) Appl. No.: 13/702,925

(22) PCT Filed: Jun. 1, 2011
(86) PCT No.: PCT/FR2011/051253

§ 371 Date: Mar. 13, 2013

(30) Foreign Application Priority Data
Jun. 8, 2010 (FR) 1054507

(51) Int. Cl. H01P 1/203

(52) U.S. Cl. CPC H01P 1/207
USPC 333/205

(57) ABSTRACT

A triangular patch resonator with a triangle pattern (30), two sides of the triangle symmetrical with respect to an axis being respectively associated with an input coupler and an output coupler, including slots in the form of a three-branch star, a first slot (41) extending along said axis, on either side of the centre of the triangle, the two other slots (42, 43) extending symmetrically from the base of the first slot, none of the branches opening out to the outside, an adjustable capacitor (51-53) being connected across each of the slots.

### FIELD OF THE INVENTION

The present invention relates to a tunable patch resonator filter.

### STATE OF THE ART

Among devices capable of being used as filters, and especially as bandpass filters, in the radio frequency domain, ranging from some hundred MHz to 10 GHz or more, it has been provided, especially in an article by Ariana L. C. Serrano et al “A Tunable Bandpass Patch Filter”, published in IEEE Proceedings International Workshop on Microwave Filters, November 2009, to use a circular patch resonator filter comprising slots, of the type illustrated in top view in FIG. 1A and in cross-section view in FIG. 1B.

As illustrated in FIGS. 1A and 1B, a patch resonator of the type described in the above-mentioned article comprises, on the lower surface side of a dielectric substrate 1, a metal plane 2, currently a ground plane, and on the upper surface side, a printed metallization or patch 4, of circular shape. In this example, the printed metallization or patch is connected, in the case of a filter, between an input microstrip 6 and an output microstrip 7, very schematically shown.

This article indicates that the patch may be provided with slots 11 to 14 extending substantially radially, all the way to the patch periphery. Such slots have identical or different lengths. The resonator bandwidth and central frequency are modified according to the characteristics of the slots.

This article also provides arranging capacitors 21 to 24 across the slots, for example, substantially in median position. This article mentions that, if capacitors 21 to 24 are formed by varactors, a device having a frequency and a bandwidth which are remotely settable may be obtained, by adjusting the varactor bias voltage, which enables to form a remotely-controllable filter.

However, tests subsequently carried out by the present inventors have shown that this type of circular patch resonator with radial slots and adjustable capacitors, although it has the advantages of allowing a remote setting disclosed in the above-mentioned article, also has the disadvantage that it is very difficult to adjust the values of the various capacitances to obtain a desired setting and a filter bandwidth that can be shifted and widened in predetermined fashion. More specifically, in the case of a circular patch resonator with radial slots and with adjustable capacitors, it is not possible to modify the central frequency of the filter without modifying its bandwidth. This is due to the fact that in such a filter, each varactor simultaneously affects more than one resonance mode.

### SUMMARY

An object of an embodiment of the present invention is to provide a patch resonator filter which is adjustable in determined and predeterminable fashion.

A more specific object of the present invention is to provide such a filter where it is possible to set in selected fashion either the bandwidth, or the central band of a filter, and where these two settings can be performed independently from each other.

To achieve these and other objects, an embodiment of the present invention provides a triangular patch resonator with a triangle pattern, two sides of the triangle symmetrical with respect to an axis being respectively associated with an input coupler and an output coupler, comprising slots in the form of a three-branch star, a first slot extending along said axis, on either side of the center of the triangle, the two other slots extending symmetrically from the base of the first slot, none of the branches opening out to the outside, an adjustable capacitor being connected across each of the slots.

According to an embodiment of the present invention, the triangle is an equilateral triangle.

According to an embodiment of the present invention, each adjustable capacitor comprises a varactor.

According to an embodiment of the present invention, a method for adjusting a filter comprising a resonator such as hereabove comprises, to set the high cut-off frequency of the resonator, the step of varying the capacitance of the capacitor arranged on the first slot.

According to an embodiment of the present invention, a method for adjusting a filter comprising a resonator such as hereabove comprises, to vary the low cut-off frequency of the resonator, the step of varying the capacitance of the capacitors associated with said two other slots.

According to an embodiment of the present invention, a method for adjusting a filter comprising a resonator such as hereabove comprises, to vary the bandwidth, the step of varying the capacitances of the capacitor assembly, the sum of the capacitances of the first capacitor and of one of the two other capacitors being maintained constant.

According to an embodiment of the present invention, a method for adjusting a filter comprising a resonator such as hereabove comprises, to shift the bandwidth, the step of varying the capacitances of the capacitor assembly, the difference between the capacitances of the first capacitance and of one of the other two capacitors being maintained constant.

### BRIEF DESCRIPTION OF THE DRAWINGS

The foregoing and other objects, features and advantages of the present invention will be discussed in detail in the following non-limiting description of specific embodiments in connection with the accompanying drawings, among which:

FIGS. 1A and 1B are a top view and a cross-section view along plane B-B of FIG. 1A of a circular patch resonator;

FIGS. 2A and 2B are a top view and a detail view of a triangular patch resonator; and

FIGS. 3 to 7 show curves useful to the discussion of the operation of the tunable triangular patch resonator of FIG. 2A.

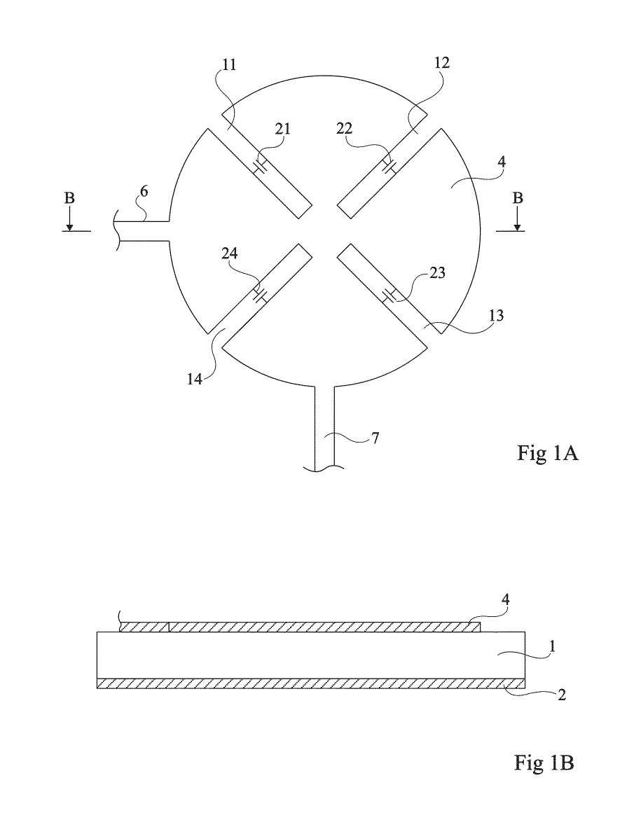

### DETAILED DESCRIPTION

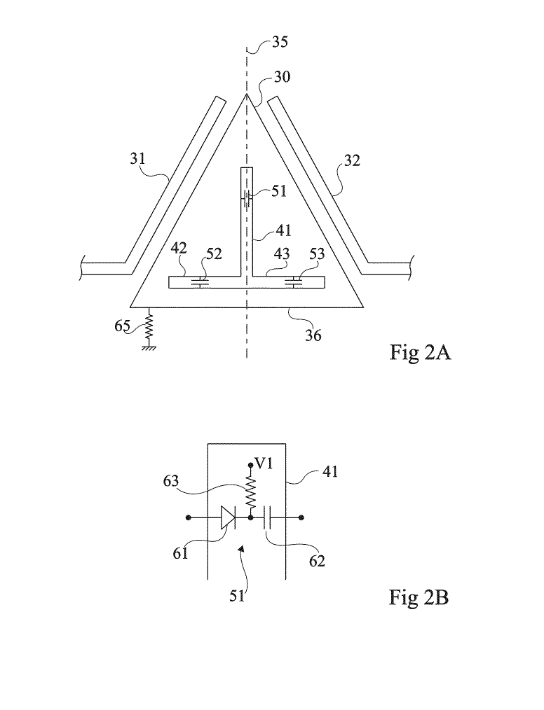

FIG. 2A is a top view of a resonator with a metal pattern or triangular patch associated with an input coupler 31 and with an output coupler 32. In this example, the input and output couplers are shown in the form of microstrips arranged parallel to two sides of the triangular resonator. It should however be noted that any other system of coupling of RF input and output signals may be useful.

An axis 35 of the triangular resonator orthogonal to the side which is not associated with an input or output coupler, which will be called base side 36, is defined. The triangle is symmetrical with respect to axis 35, and is preferably equilateral.

Along axis 35 extends a slot 41. Slot 41 extends on either side of the center of the triangle and does not open out to the outside of the metallization forming triangular resonator 30. On the lower side of slot 41, extend two lateral slots 42 and 43 symmetrical with respect to axis 35. Such slots may, as shown, be rectilinear or orthogonal to slot 41. They may also have any other shape, for example, semi-circular, their ends being directed towards base 36, or rectilinear but inclined with their ends pointing towards base 36. The effect of these slots is to decrease the resonance frequency of the two fundamental resonance modes of the triangular resonator.

Further, adjustable capacitors 51, 52, 53 are arranged across slots 41, 42, and 43 in a median portion of each of the slots. Such capacitors are for example arranged between the first and the second third of the length of each of the slots. Capacitor 51 has a value C1. Capacitors 52 and 53 preferably have a same value C2 and are arranged symmetrically.

FIG. 2B is an enlarged view of a portion of slot 41 and shows a possible embodiment of a voltage-controlled adjustable capacitor 51. It should be clear to those skilled in the art that other embodiments of an adjustable capacitor can be envisaged. The actual variable capacitor is formed by a varactor 61. To avoid a short-circuit for D.C. current, the varactor is in series with a capacitor 62 for example formed of a diode reversely assembled with respect to diode 61. The junction point of varactor 61 and of capacitor 62 is connected to a settable D.C. voltage source V1 via a resistor 63. Further, as illustrated in FIG. 2A, metal pattern 30 is grounded by a resistor 65 to provide a bias reference. Resistors 63 and 65 have high values to avoid RF signal losses.

As an example, GaAs varactors having a capacitance capable of significantly varying for a bias voltage varying between 0 and 20 volts are known.

It will be shown that, conversely to the case of the use of a circular resonator, the use of a triangular resonator enables to obtain easily-predictable settings of the central frequency and of the bandwidth of the resonator, and thus of the filter formed by the assembly of this resonator with an input coupler and an output coupler.

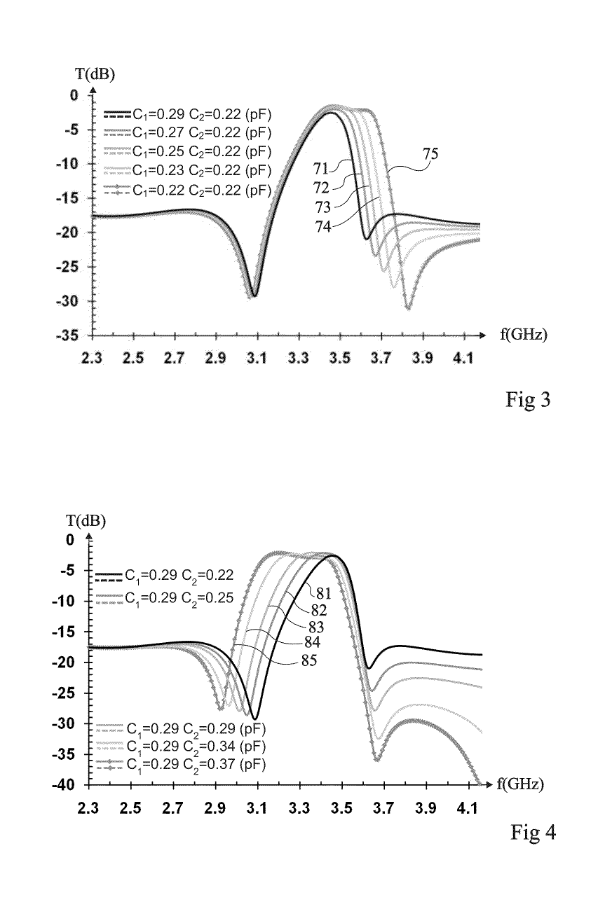

FIGS. 3 to 7 illustrate various characteristics of the filter, simulated and verified, in the case of a triangular patch resonator filter having the following features:

substrate of permittivity ε=10.2, and of thickness=0.635 nm,

equilateral triangle with a 12-mm side,

length of slot 41: 5.2 mm,

length of lateral slots 42, 43: 4.5 mm,

slot width: 0.5 mm.

FIG. 3 shows transmission curves T in dB of the filter for a constant value of capacitances C2 (0.22 pF) and values of capacitance C1 variable from 0.29 to 0.22 pF, that is, for a bias voltage of capacitances C2 of 20 volts and for bias voltages of capacitance C1 varying from 8 to 20 volts. It can be observed that the various curves 71 to 75 are such that the low cut-off frequency (approximately 3.1 GHz) substantially does not vary while the high cut-off frequency substantially varies from 3.6 to 3.8 GHz. Thus, when capacitance C1 decreases, the filter bandwidth increases without for the low cut-off frequency to vary.

FIG. 4 shows transmission curves 81 to 85 for a constant value (0.29 pF) of capacitance C1 and variable values, from 0.22 to 0.37 pF, of capacitances C2. Here, and in the following, it is considered that the two capacitors 52 and 53 of same capacitance C2 are varied together. In this case, it can be observed that the high cut-off frequency does not substantially vary and remains at a value close to 3.7 GHz while the low cut-off frequency varies from 3.1 to substantially 2.9 GHz. Thus, when capacitances C2 increase, the filter bandwidth increases without for the high cut-off frequency to vary.

By combining the variations of capacitance C1 and of the two capacitances C2, the transmission curve of a filter can thus be modified in determinable fashion.

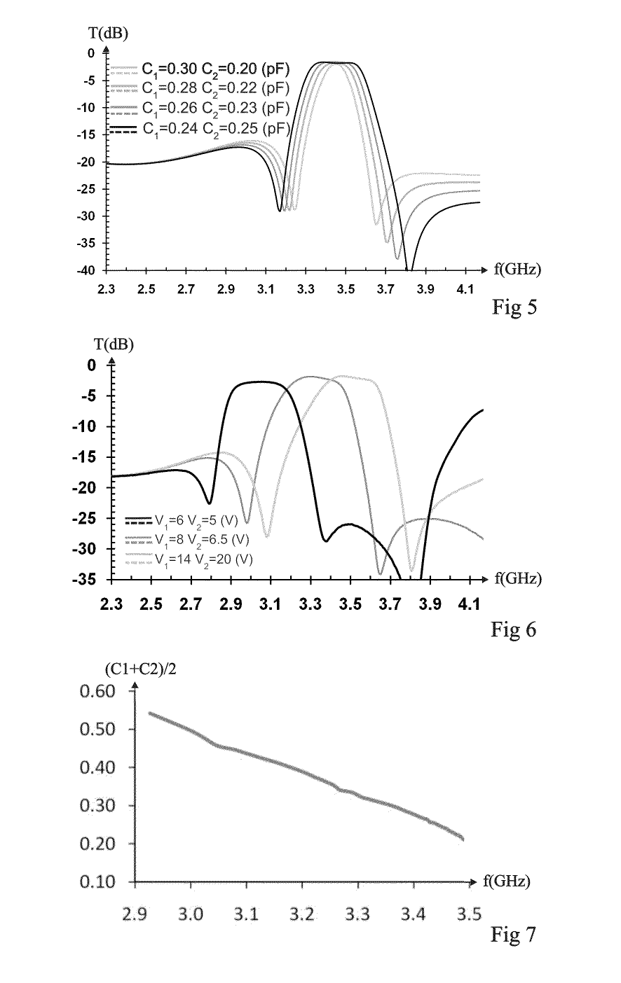

As illustrated in FIG. 5, by simultaneously varying capacitances C1 and C2 while keeping sum C1+C2 constant, a same central transmission frequency can be kept and the bandwidth can be widened or narrowed, in determined fashion.

In the case of FIG. 6, the values of capacitances C1 and C2 are simultaneously varied by keeping difference C1−C2 substantially constant. A constant bandwidth is then obtained while the central frequency of the filter shifts. It should be noted that, in FIG. 6, instead of indicating capacitance variations, bias voltage variations have been indicated, which is equivalent.

Further, FIG. 7 shows the central frequency in abscissas of the triangular pattern resonator according to the average value (C1+C2)/2 of above-mentioned capacitances C1 and C2. It can be seen that this characteristic is substantially linear, that is, the results are well predictable, as illustrated in FIG. 5.

Thus, an embodiment of a patch filter having determinable central frequency and bandwidth variability characteristics is provided herein. It is thus possible to remotely control the transmission curve of a filter by acting on the bias voltages of settable capacitors, or by remotely controlling in any other way settable capacitors, which may be useful for a filter installed in an inaccessible location, for example, a satellite.

1. A triangular patch resonator with a triangle pattern, two sides of the triangle symmetrical with respect to an axis being respectively associated with an input coupler and an output coupler, comprising slots in the form of a three-branch star, a first slot extending along said axis, on either side of the center of the triangle, the two other slots extending symmetrically from the base of the first slot, none of the branches opening out to the outside, an adjustable capacitor being connected across each of the slots.

2. The resonator of claim 1, wherein said triangle is an equilateral triangle.

3. The resonator of claim 1, wherein each adjustable capacitor comprises a varactor.

4. A method for adjusting a filter comprising the resonator of claim 1, comprising, to set the high cut-off frequency of the resonator, the step comprising varying the capacitance of the capacitor arranged on the first slot.

5. A method for adjusting a filter comprising the resonator of any of claim 1, comprising, to vary the low cut-off frequency of the resonator, the step of varying the capacitance of the capacitors associated with said two other slots.

6. A method for adjusting a filter comprising the resonator of claim 1, comprising, to vary the bandwidth, the step of varying the capacitances of the capacitor assembly, the sum of the capacitances of the first capacitor and of one of the two other capacitors being maintained constant.

7. A method for adjusting a filter comprising the resonator of claim 1, comprising, to shift the bandwidth, the step of varying the capacitances of the capacitor assembly, the difference between the capacitances of the first capacitance and of one of the two other capacitors being maintained constant.
